(19) United States
(12) Patent Application Publication
(10) Pub. No.: US 2012/0300725 A1
(43) Pub. Date: Nov. 29, 2012

(54) SYSTEM INFORMATION TRANSMISSION AND RECEIVING METHOD OF MULTIPLE COMPONENT CARRIERS AND DEVICE THEREOF, AND SYSTEM INFORMATION TRANSMITTING AND RECEIVING/UPDATING DEVICE USING SAME

(75) Inventors: Kibum Kwon, Ansan-si (KR); Myungcheul Jung, Seoul (KR)

(73) Assignee: PANTECH CO., LTD., Seoul (KR)

(21) Appl. No.: 13/521,603

(22) PCT Filed: Dec. 30, 2010
(86) PCT No.: PCT/KR10/09552

§ 371 Date: Jul. 11, 2012

(30) Foreign Application Priority Data
Jan. 12, 2010 (KR) 10-2010-0002598

(51) Int. Cl. H04W 72/04

(52) U.S. Cl. 370/329

(57) ABSTRACT

A base station and a user equipment (UE) transmit and receive one or more of a system information (SI) change notification message, which includes SI change notification information of a first component carrier in which system information is changed, and an SI validity verification message, which includes SI validity verification information of the first component carrier in which the system information is changed, in order to transmit and receive the system information in a wireless communication system using at least one component carrier; and the SI is transmitted by determining a transmission type of the system information according to priority between QoSs and power consumption of the UE, without generating an additional increase of signal quantities or power consumption when the SI is transmitted.

### CROSS-REFERENCE TO RELATED APPLICATIONS

This application is the National Stage Entry of International Application No. PCT/KR2010/009552, filed on Dec. 30, 2010, and claims priority from and the benefit of Korean Patent Application No. 10-2010-0002598, filed on Jan. 12, 2010, both of which are incorporated herein by reference for all purposes as if fully set forth herein.

### BACKGROUND

1. Field

The present disclosure which relates to a wireless communication system, relates to a method and a device for transmitting and receiving system information (SI) of multiple component carriers, and a device for transmitting/receiving and updating system information using the same.

More particularly, the present invention relates to a technology for transmitting system information change notification information or system information validity verification information through a component carrier (CC), system information of which has been changed, and selectively using a scheme for transmitting the changed system information according to a characteristic of the component carrier, the system information of which has been changed, the state of a UE, the range of the changed system information, etc., in a wireless communication system where multiple component carriers are operated.

2. Discussion of the Background

With the progress of communication systems, consumers such as companies and individuals have used a wide variety of wireless terminals.

In current mobile communication systems such as 3GPP LTE (3^{rd} Generation Partnership Project Long Term Evolution) and LTE-A (LTE Advanced), as a high-speed and high-capacity communication system capable of transmitting and receiving various data such as images and wireless data beyond voice-oriented services, it is required to develop a technology capable of transmitting a large amount of data coming close to that of a wired communication network. In addition, an appropriate error detection scheme in which system performance can be improved by minimizing information loss and increasing system transmission efficiency, becomes an essential element.

Meanwhile, up to the present, differently from a communication system using one carrier in one frequency band, in a wireless communication system which has recently been discussed, a method which enables the use of multiple Component Carriers (CCs), is under discussion.

Meanwhile, generally, in a mobile communication system, a User Equipment (UE) acquires multiple parameters (e.g. the initialization of the UE after power-on, a call connection, etc.) required for the operation of the UE, from System Information (SI) broadcasted by a Base Station (BS). The system information is propagated to all cells in which all UEs can receive the system information through a broadcast channel.

In the case of a communication system using multiple component carriers, each component carrier can serve as one cell. Accordingly, system information of each component carrier must be notified to UEs. Particularly, because system information includes time-varying parameters, it is always required to transmit up-to-date system information to UEs. However, up to the present, no determination has been made for this technology.

### SUMMARY

Therefore, an aspect of the present invention is intended to provide a method and a device for efficiently transmitting changed system information of multiple component carriers to a user equipment. Also, the present invention is intended to provide a device in which a user equipment effectively receives changed system information of multiple component carriers and updates system information of the multiple component carriers by using the received changed system information thereof.

Also, the present invention is intended to provide a technology for transmitting system information change notification information or system information validity verification information through a component carrier, system information of which has been changed, and selectively using a scheme for transmitting the changed system information according to a characteristic of the component carrier, the system information of which has been changed, the state of a UE, the range of the changed system information, etc.

In order to accomplish the above-mentioned objects, in accordance with an aspect of the present invention, there is provided a method for transmitting system information (SI) in a wireless communication system using one or more component carriers. The method includes: transmitting, to a user equipment, one or more of an SI change notification message including SI change notification information of a first component carrier, system information of which has been changed, and an SI validity verification message including SI validity verification information of the first component carrier, the system information of which has been changed; determining a scheme for transmitting the changed system information based on one or more of a characteristic of the first component carrier, the system information of which has been changed, whether the user equipment is capable of receiving a signal, and a range of the changed system information; and transmitting the changed system information to the user equipment in the determined scheme, wherein the scheme for transmitting the changed system information corresponds to any one of: 1) a first scheme for transmitting the changed system information through the first component carrier, the system information of which has been changed; 2) a second scheme for transmitting the changed system information through a predetermined second component carrier; 3) a third scheme for transmitting the changed system information through higher layer signaling; and 4) a fourth scheme for transmitting system information for only a particular user equipment among the multiple pieces of changed system information through the higher layer signaling, and for transmitting system information, which is commonly applied to all user equipments within a cell among the multiple pieces of changed system information, through the first component carrier, the system information of which has been changed.

In accordance with another aspect of the present invention, there is provided a method for transmitting system information (SI) in a wireless communication system using one or more component carriers. The method includes: determining a characteristic of a component carrier, system information of which has been changed, or a characteristic of a user equipment, a state of which has been changed; and transmitting the changed system information together with an SI validity verification message including SI validity verification information of the component carrier, the system information of which has been changed, to the user equipment through the component carrier, the system information of which has been changed, according to a result of determining of the characteristic.

In accordance with another aspect of the present invention, there is provided a method for receiving system information (SI) in a wireless communication system using one or more component carriers. The method includes: receiving, from a base station, one or more of an SI change notification message including SI change notification information of a first component carrier, system information of which has been changed, and an SI validity verification message including SI validity verification information of the first component carrier, the system information of which has been changed; and receiving the changed system information of the first component carrier from the base station in a scheme determined by the base station, wherein the scheme determined by the base station corresponds to any one of: 1) a first scheme for receiving the changed system information through the first component carrier, the system information of which has been changed; 2) a second scheme for receiving the changed system information through a predetermined second component carrier; 3) a third scheme for receiving the changed system information through higher layer signaling; and 4) a fourth scheme for receiving system information for only a particular user equipment among the multiple pieces of changed system information through the higher layer signaling, and for receiving system information, which is commonly applied to all user equipments within a cell among the multiple pieces of changed system information, through the first component carrier, the system information of which has been changed.

In accordance with another aspect of the present invention, there is provided a method for receiving system information (SI) in a wireless communication system using one or more component carriers. The method includes: receiving changed system information together with an SI validity verification message including SI validity verification information of a component carrier, the system information of which has been changed, through the component carrier, the system information of which has been changed, according to a result of determining, by a base station, a characteristic of the component carrier, the system information of which has been changed, or a characteristic of a user equipment, a state of which has been changed; and updating the system information by using the received system information.

In accordance with another aspect of the present invention, there is provided a device for transmitting system information (SI) in a base station transmitting system information in a wireless communication system using one or more component carriers. The device includes: a transmitter for transmitting, to a user equipment, one or more of an SI change notification message including SI change notification information of a first component carrier, system information of which has been changed, and an SI validity verification message including SI validity verification information of the first component carrier, the system information of which has been changed; and a controller for determining a scheme for transmitting the changed system information based on one or more of a characteristic of the first component carrier, the system information of which has been changed, whether the user equipment is capable of receiving a signal, and a range of the changed system information, wherein the transmitter transmits the changed system information to the user equipment in the scheme determined by the controller, and wherein the scheme in which the transmitter transmits the changed system information, corresponds to any one of: 1) a first scheme for transmitting the changed system information through the first component carrier, the system information of which has been changed; 2) a second scheme for transmitting the changed system information through a predetermined second component carrier; 3) a third scheme for transmitting the changed system information through higher layer signaling; and 4) a fourth scheme for transmitting system information for only a particular user equipment among the multiple pieces of changed system information through the higher layer signaling, and for transmitting system information, which is commonly applied to all user equipments within a cell among the multiple pieces of changed system information, through the first component carrier, the system information of which has been changed.

In accordance with another aspect of the present invention, there is provided a device for transmitting system information (SI) in a wireless communication system using one or more component carriers. The device includes: a controller for determining a characteristic of a component carrier, system information of which has been changed, or a characteristic of a user equipment, a state of which has been changed; and a transmitter for transmitting the changed system information together with an SI validity verification message including SI validity verification information of the component carrier, the system information of which has been changed, to the user equipment through the component carrier, the system information of which has been changed, according to a result of determining of the characteristic.

In accordance with another aspect of the present invention, there is provided a device for receiving system information (SI) in a device for receiving and updating system information in a wireless communication system using one or more component carriers. The device includes: a receiver for receiving, from a base station, one or more of an SI change notification message including SI change notification information of a first component carrier, system information of which has been changed, and an SI validity verification message including SI validity verification information of the first component carrier, the system information of which has been changed, and for receiving the changed system information of the first component carrier from the base station in a scheme determined by the base station; and a controller for controlling the receiver so as to receive one or more of the SI change notification message or the SI validity verification message in the scheme determined by the base station, and updating the system information by using the received system information, wherein the scheme determined by the base station corresponds to any one of: 1) a first scheme for receiving the changed system information through the first component carrier, the system information of which has been changed; 2) a second scheme for receiving the changed system information through a predetermined second component carrier; 3) a third scheme for receiving the changed system information through higher layer signaling; and 4) a fourth scheme for receiving system information for only a particular user equipment among the multiple pieces of changed system information through the higher layer signaling, and for receiving system information, which is commonly applied to all user equipments within a cell among the multiple pieces of changed system information, through the first component carrier, the system information of which has been changed.

In accordance with another aspect of the present invention, there is provided a device for receiving system information (SI) in a device for receiving and updating system information in a wireless communication system using one or more component carriers. The device includes: a receiver for receiving changed system information together with an SI validity verification message including SI validity verification information of a component carrier, the system information of which has been changed, through the component carrier, the system information of which has been changed, according to a result of determining, by a base station, a characteristic of the component carrier, the system information of which has been changed, or a characteristic of a user equipment, a state of which has been changed; and a controller for updating the system information by using the received system information.

### BRIEF DESCRIPTION OF THE DRAWINGS

FIG. 1 is a view schematically showing a wireless communication system providing a method for transmitting and receiving system information of multiple component carriers according to an exemplary embodiment of the present invention.

FIG. 2 is a view showing an example of changing system information in a communication system using multiple component carriers.

FIG. 3 is a view showing another example of changing system information in a communication system using multiple component carriers.

FIG. 4 is a view showing an example of a component carrier which may be used in the present invention.

FIG. 5 shows a timing diagram in which system information is updated according to an embodiment of the present invention.

FIG. 6 is a flowchart showing a method for transmitting SI according to a first embodiment of the present invention.

FIG. 7 is a flowchart showing a method for transmitting SI according to a second embodiment of the present invention.

FIG. 8 is a flowchart showing a method for transmitting SI according to a third embodiment of the present invention.

FIG. 9 is a block diagram showing the configuration of a device for transmitting changed SI, to which a method according to each of the first to third embodiments of the present invention is applied.

FIG. 10 is a block diagram showing the configuration of a device for receiving and updating SI according to an embodiment of the present invention.

### DETAILED DESCRIPTION OF THE ILLUSTRATED EMBODIMENTS

Hereinafter, exemplary embodiments of the present invention will be described in detail with reference to the accompanying drawings. It should be noted that in assigning reference numerals to elements in the drawings, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be understood that if it is described in the specification that one component is “connected,” “coupled” or “joined” to another component, a third component may be “connected,” “coupled,” and “joined” between the first and second components, although the first component may be directly connected, coupled or joined to the second component.

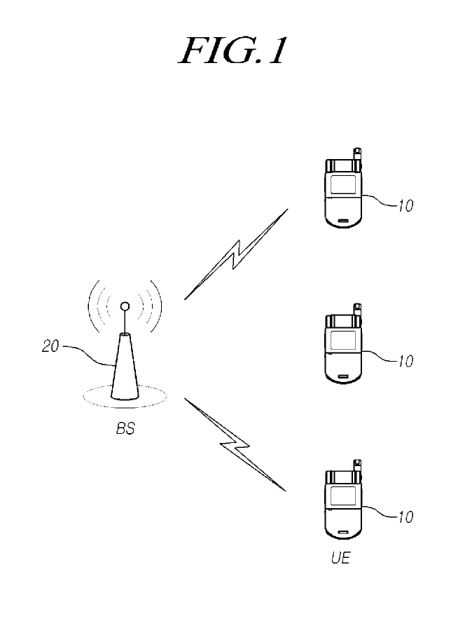

FIG. 1 is a view schematically showing a wireless communication system providing a method for transmitting and receiving system information of multiple component carriers according to an exemplary embodiment of the present invention.

The wireless communication system is widely arranged in order to provide various communication services, such as voice, packet data, etc.

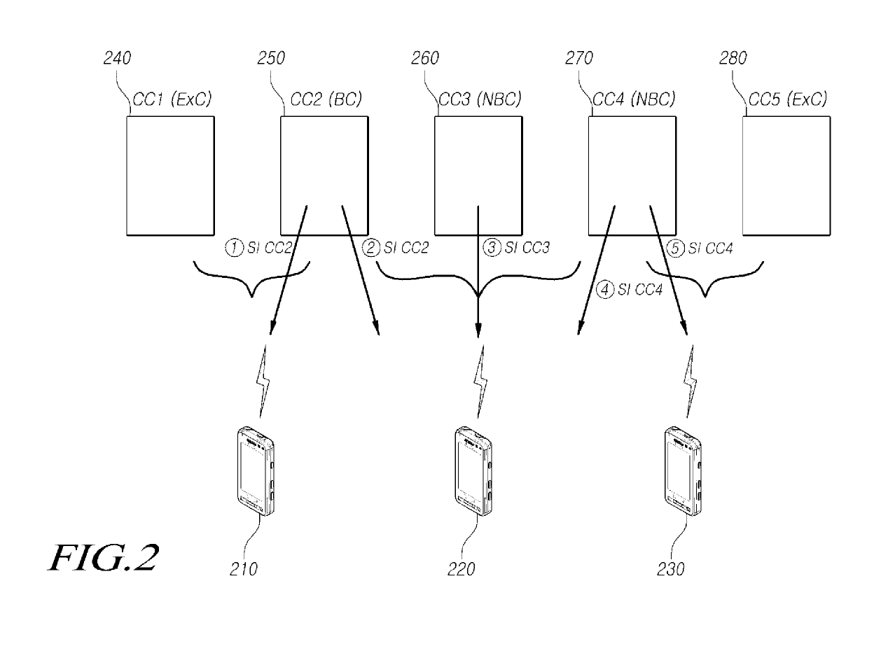

Referring to FIG. 1, the wireless communication system includes a User Equipment (UE) 10 and a Base Station (BS) 20. A technology for transmitting and receiving System Information (SI) of a component carrier, such as each of exemplary embodiments which will be described below, is applied to the UE 10 and the BS 20. Such a device and a method for transmitting and receiving SI of multiple component carriers will be described in detail with reference to the accompanying drawings after FIG. 2.

In this specification, the User Equipment (UE) 10 has a comprehensive concept implying a user terminal in wireless communication. Accordingly, the UEs should be interpreted as having the concept of including a MS (Mobile Station), a UT (User Terminal), an SS (Subscriber Station), a wireless device, and the like in GSM (Global System for Mobile Communications) as well as UEs (User Equipments) in WCDMA (Wideband Code Division Multiple Access), LTE (Long Term Evolution), HSPA (High Speed Packet Access), etc.

The BS 20 or a cell usually refers to a fixed station communicating with the UE 10, and may be called different terms, such as a Node-B, an eNB (evolved Node-B), a BTS (Base Transceiver System), an AP (Access Point), and a relay node.

In this specification, the BS 20 or the cell should be interpreted as having a comprehensive meaning indicating a partial area covered by a BSC (Base Station Controller) in CDMA (Code Division Multiple Access) or a Node-B in WCDMA (Wideband Code Division Multiple Access). Accordingly, the BS 20 or the cell has a meaning including various coverage areas such as a mega cell, a macro cell, a micro cell, a pico cell, a femto cell, and a relay node communication range.

In this specification, the user equipment 10 and the base station 20, which are two transmission and reception subjects used to implement the art or the technical idea described in this specification, are used as a comprehensive meaning, and are not limited by a particularly designated term or word.

There is no limit to multiple access schemes applied to the wireless communication system. For example, use may be made of various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA.

In this respect, use may be made of a TDD (Time Division Duplex) scheme in which uplink transmission and downlink transmission are performed at different times. Otherwise, use may be made of an FDD (Frequency Division Duplex) scheme in which uplink transmission and downlink transmission are performed by using different frequencies.

An embodiment of the present invention may be applied to the allocation of resources in the field of asynchronous wireless communications which have gone through GSM, WCDMA and HSPA, and evolve into LTE (Long Term Evolution) and LTE-A (Long Term Evolution-Advanced), and in the field of synchronous wireless communications which evolve into CDMA, CDMA-2000 and UMB. The present invention should not be interpreted as being limited to or restricted by a particular wireless communication field, and should be interpreted as including all technical fields to which the spirit of the present invention can be applied.

The wireless communication system, to which an exemplary embodiment of the present invention is applied, may support an uplink and/or downlink HARQ (Hybrid Automatic Repeat reQuest), and may use a CQI (Channel Quality Indicator) for link adaptation. Meanwhile, multiple access schemes for downlink transmission and uplink transmission may be different from each other. For example, OFDMA (Orthogonal Frequency Division Multiple Access) may be used for downlink transmission, and SC-FDMA (Single Carrier-Frequency Division Multiple Access) may be used for uplink transmission.

Layers of a radio interface protocol between a UE and a network may be divided into a first layer (L1), a second layer (L2), and a third layer (L3) based on three lower layers of an Open Systems Interconnection (OSI) model, which is widely known in a communication system. A physical layer belonging to the first layer provides an information transmission service using a physical channel.

Meanwhile, in an example of the wireless communication system to which an embodiment of the present invention is applied, one radio frame may include 10 subframes, and one subframe may include two slots.

The subframe is a basic unit of data transmission, and downlink or uplink scheduling is performed on a subframe-by-subframe basis. One slot may include multiple OFDM symbols in the time domain, and may include at least one subcarrier in the frequency domain. One slot may include 7 or 6 OFDM symbols.

For example, when one subframe includes two time slots, each time slot may include 7 symbols in the time domain, and may include 12 subcarriers in the frequency domain. Although a time-frequency domain defined by one slot as described above may be called a Resource Block (RB), the present invention is not limited to this configuration.

Meanwhile, in one of the currently-used communication systems, one carrier having a predetermined frequency bandwidth (a maximum of 20 MHz) is used. In this wireless communication system, System Information (SI) of a Component Carrier (CC) is transmitted and received through the relevant CC.

However, in a new communication system which has recently been discussed, in order to satisfy required performance, the extension of a bandwidth is under discussion. In order to extend a bandwidth, a unit carrier that the existing communication user equipment can have, is defined as a component carrier, and a method for grouping these component carriers up to a maximum of 5 and using the grouped component carriers is under discussion. It goes without saying that the number of component carriers (for example, up to a maximum of 5) is on the rise in order to meet the requirement of service quality.

Namely, multiple conventional component carriers each having a bandwidth of 20 MHz may be grouped and the multiple grouped component carriers may be used. For example, the extension of a bandwidth may be achieved in such a manner that five component carriers are grouped and the five grouped component carriers have a bandwidth up to a maximum of 100 MHz. A technology in which multiple component carriers may first be grouped and may then be used as described above, is called a carrier aggregation technology. A frequency band that component carriers may be allocated may be continuous, or may be discontinuous.

In relation to the carrier aggregation technology, multiple component carriers may be divided into three types, such as a backwards compatible carrier (BC), a non-backwards compatible carrier (NBC) and an extension carrier (ExC), according to characteristics thereof. It goes without saying that as characteristics of the multiple component carriers become more diversified, the multiple component carriers may be divided into more types than the three types.

A backwards compatible carrier is a carrier accessible to UEs of all existing LTE releases. The backwards compatible carrier may be operated as a single carrier (stand-alone) or as a part of a carrier aggregation. For Frequency Division Duplex (FDD), backwards compatible carriers may always occur in pairs (i.e. uplink and downlink).

Meanwhile, a non-backwards compatible carrier is a carrier which is not accessible to UEs complying with communication systems which do not support the NBC. The non-backwards compatible carrier may be operated as a single carrier (stand-alone) if the non-backwards compatibility originates from a duplex distance, or otherwise may be operated as a part of a carrier aggregation.

Also, an extension carrier is a carrier which may not be operated as a single carrier (stand-alone) but must be used as only a part of at least one component carrier set including a stand-alone-capable carrier. The extension carrier is used only for bandwidth extension.

In an environment of the multiple CCs, a UE may be allocated multiple CCs, each of which enables the reception of a signal. For an appropriate operation of each allocated CC, the UE needs to acquire up-to-date SI of each CC.

In a case where only one CC is used in downlink as in the conventional LTE and the like, when SI of the relevant CC is changed, the changed SI, together with notification of the change of the SI, is transmitted to the UE through the relevant component carrier.

However, when a wireless system where multiple CCs are operated is considered, there is a need for a new method for SI change notification and the transmission of the changed SI.

FIG. 2 is a view showing an example of changing system information in a communication system using multiple component carriers.

An example of FIG. 2, which illustrates a simple extension of the conventional scheme for changing SI in the case of using a single CC, to a multiple component carriers system, corresponds to a scheme for transmitting changed SI through a relevant CC, the SI of which has been changed.

More specifically, the UE2 220 uses the CC2 250, the CC3 260 and the CC4 270, and receives and acquires system information of each CC through the relevant CC. In this case, the system information may be all pieces of system information of the CC2 250, the CC3 260 and the CC4 270, and may be a part of changed system information. The UE2 220 receives and acquires (\textcircled{2}) system information or changed system information of the CC2 250 (SI CC2) through the CC2. The UE2 220 receives and acquires (\textcircled{3}) system information of the CC3 260 (SI CC3) through the CC3. The UE2 220 receives and acquires (\textcircled{4}) system information of the CC4 270 (SI CC4) through the CC4. When system information of each CC is changed, the UE2 220 receives and acquires the changed system information in the same manner as described above.

When system information of each CC is transmitted and received only through the relevant CC as shown in FIG. 2, as compared with a conventional communication system, system information signaling overhead does not increase, and a scalability problem does not occur. On the other hand, in the case of discontinuous reception (DRX) and the like, paging information and the like related to the relevant CC must be received through the relevant CC. Accordingly, a problem of wasting battery resources of a UE using the battery resources may occur.

Namely, in order to receive system information newly updated due to a change of system information and the like, the UE2 shown in FIG. 2 continuously monitors the CC2, the CC3 and the CC4, which are component carriers used by the UE2. After the UE2 detects that the system information has been newly updated, the UE2 must receive the changed system information of each relevant CC through each relevant CC. In this case, the power consumption of a battery of the UE2 may become significant.

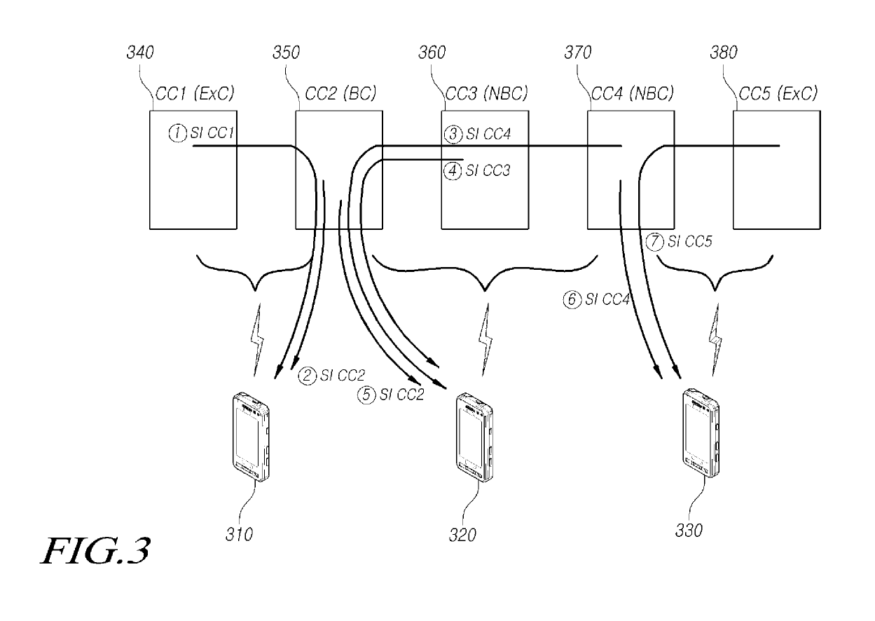

FIG. 3 is a view showing another example of changing system information in a communication system using multiple component carriers.

Another example of FIG. 3 illustrates a scheme for transmitting changed SI through one special CC (or one special cell) which is specially defined regardless of a CC, SI of which has been changed.

Namely, in another example of FIG. 3, use is made of a scheme for transmitting SI of changed CCs to a UE through a special CC corresponding to a particular CC resource.

In FIG. 3, as described above with reference to FIG. 2, a UE1 310 is in a state where it may transmit data through a CC1 340 and a CC2 350. A UE2 320 is in a state where it may transmit data through a CC2 350, a CC3 360 and a CC4 370. Also, a UE3 330 is in a state where it may transmit data through a CC4 370 and a CC5 380. It is assumed in FIG. 3 that the CC2 is a backwards compatible carrier (BC), each of the CC3 and the CC4 is a non-backwards compatible carrier (NBC), and each of the CC1 and the CC5 is an extension carrier (ExC).

Referring to FIG. 3, each of the UE1 310 and the UE2 320 makes a connection for signaling through the CC2 350, and the UE3 330 makes a connection for signaling through the CC4 370.

In this case, a CC through which a connection is made for signaling, is called a special CC (or special cell). An example of the special CC may be an anchor carrier or a primary cell or a serving cell or a special cell. However, the present invention is not limited to this term and this example.

The special CC may provide multiple pieces of information for a signaling connection to a UE. For example, the special CC (or special cell) may generate and provide a key for ensuring security between a system and the UE. Otherwise, the special CC may transmit mobility-related information and the like, which are generated and transmitted by a core network for ensuring mobility.

In the exemplary embodiment as shown in FIG. 3, differently from as shown in FIG. 2, system information of another allocated CC may be transmitted through the special component carrier which plays a role (e.g. signaling connection).

Namely, the UE2 320 detects changed contents of SI of the CC2 350, SI of the CC3 360 and SI of the CC4 370. Then, in order to receive SI of the relevant CC3 360 and SI of the relevant CC4 370, the UE2 320 does not need to receive the changed SI through all the changed CCs CC3 and CC4, but may receive the changed SI of the CC3 360 and the changed SI of the CC4 370 through the CC2 350. Otherwise, not only changed SI of a CC but also all pieces of system information for using the CC3 360, the CC4 370 and the like or a part thereof may be transmitted through the CC2 350, instead of through the relevant CC.

At this time, a signaling connection that a UE makes through a special CC, may be made through RRC (Radio Resource Control). However, the present invention is not limited to this configuration. Each UE receives and acquires system information of another CC through a special CC.

Also, although not shown in the accompanying drawings, instead of using RRC and the like corresponding to a typical signaling between a UE and a particular CC, a scheme for notifying the UE of a change of SI through higher layer signaling, a scheme for transmitting the changed SI itself to the UE, and the like may be considered.

The schemes for changing SI as shown in FIGS. 2 and 3, and such as higher layer signaling, have disadvantages such as an increase in power consumption of a UE, a need for providing additional information to a CC, SI of which has been changed, and an increase in the amount of information, which is caused by adding new signaling.

Accordingly, in a first embodiment of the present invention, a method for transmitting changed SI of a particular CC to a UE when the SI of the particular CC is changed in a wireless communication system using one or more CCs, may include: transmitting an SI change notification message including SI change notification information of the CC, the SI of which has been changed, to the UE; and transmitting the changed SI to the UE in one or more of the following four schemes determined based on one or more of a characteristic of the CC (a first CC), the SI of which has been changed, whether the UE may receive a signal, and a range of the changed SI. The above four schemes may include: 1) a first scheme for transmitting the changed SI through the relevant CC (the first CC), the SI of which has been changed, 2) a second scheme for transmitting the changed SI through a predetermined special CC (a second CC), 3) a third scheme for transmitting the changed SI through higher layer signaling, and 4) a fourth scheme for transmitting SI for only a particular UE among the multiple pieces of changed SI through higher layer signaling, and for transmitting SI, which is commonly applied to all UEs within a cell among the multiple pieces of changed SI, through the relevant CC (the first CC), the SI of which has been changed. However, the present invention is not limited to this configuration. Herein, the second CC may be any one of an anchor carrier, a primary cell, a serving cell, and a special cell. The SI change notification message may be variously transmitted, and thus may be transmitted through the special CC (the second CC) as described above.

In the first embodiment of the present invention, the SI change notification message may be a paging message, or may be a message having a function equivalent to that of the paging message. However, the present invention is not limited to this configuration.

In a second embodiment of the present invention, a method for transmitting changed SI of a particular CC to a UE when the SI of the particular CC is changed in a wireless communication system using one or more CCs, may include: transmitting an SI validity verification message including SI validity verification information of the CC (e.g. a first CC), the SI of which has been changed, to the UE; and transmitting the changed SI to the UE in one or more of the following four schemes determined based on one or more of a characteristic of the CC (i.e. the first CC), the SI of which has been changed, whether the UE may receive a signal, and a range of the changed SI. The SI validity verification message may be variously transmitted, and thus may be transmitted through the special CC (the second CC) as described above.

In the second embodiment of the present invention, the SI validity verification message may be included in a fixed and periodic SI transmission block or in a message having a function equivalent to that of the fixed and periodic SI transmission block. However, the present invention is not limited to this configuration.

In a third embodiment of the present invention, a method for transmitting changed SI of a particular CC to a UE when the SI of the particular CC is changed in a wireless communication system using one or more CCs, may include transmitting the changed SI to the UE, together with an SI validity verification message including SI validity verification information of the CC, the SI of which has been changed, through the relevant CC, the SI of which has been changed, only when a particular condition is satisfied by one or more parameters among a characteristic of the CC, SI of which has been changed, and whether the UE may receive a signal.

Also, an example of a method for updating SI by the UE according to the present invention includes: receiving SI change notification information according to the first embodiment of the present invention at a time point of completion of an (n-1)^{th} SI update period; discarding the existing SI of the CC, the SI of which has been changed; and receiving the changed SI and updating SI by using the changed SI during an n^{th} update period.

Also, an example of a method for updating SI by the UE according to the present invention includes: receiving SI validity verification information according to the second embodiment of the present invention at a time point of completion of an (n-1)^{th} SI update period; verifying the validity of SI; discarding the existing SI of a relevant CC only when the validity verification fails; and receiving the changed SI and updating SI by using the changed SI during an n^{th} update period.

Also, an example of a method for updating SI by the UE according to the present invention includes: simultaneously receiving SI validity verification information and changed SI according to the third embodiment of the present invention at a time point of completion of an n^{th} SI update period; and verifying the validity of SI; and discarding the existing SI of a relevant CC and updating SI to the changed SI, only when the validity verification fails.

At this time, one or more of the following four schemes determined based on one or more of a characteristic of a CC, SI of which has been changed, whether a UE may receive a signal, and the range of changed SI, may be used as a scheme for receiving changed SI by the UE. The four schemes may include: 1) a first scheme for receiving changed SI through a relevant CC, the SI of which has been changed, 2) a second scheme for receiving changed SI through a predetermined special CC, 3) a third scheme for receiving changed SI through higher layer signaling, and 4) a fourth scheme for receiving SI for only a particular UE among the multiple pieces of changed SI through higher layer signaling, and for receiving SI, which is commonly applied to all UEs within a cell among the multiple pieces of changed SI, through the relevant CC, the SI of which has been changed. However, the present invention is not limited to this configuration.

Herein, a characteristic of a CC, SI of which has been changed, whether a UE may receive a signal, the range of changed SI, and the like may be used as parameters determining a scheme for transmitting changed SI. These parameters may include the following detailed criteria. However, the present invention is not limited to this configuration.

Firstly, detailed criteria related to a characteristic of a CC, SI of which has been changed, may include: whether the relevant CC is an independently-operated CC or is a dependently-operated CC, whether control information may be transmitted through the relevant CC, whether SI may be transmitted through the relevant CC, whether the relevant CC has a Signal-to-Interference plus Noise Ratio (SINR) equal to or greater than a threshold, etc.

Secondly, detailed criteria related to whether a UE may receive a signal, may include: whether the UE may receive a signal through a CC, SI of which has been changed, whether the UE may receive a signal through a CC, SI of which is not changed, etc. Examples of these detailed criteria may include: whether the UE is in an activated state or in a non-activated state, whether a relevant CC is configured or non-configured to the UE, etc.

Thirdly, detailed criteria related to the range of changed SI may include: whether the changed SI is common information commonly applied to all users within a cell or is information applied only to a particular UE within the cell, whether the changed SI includes the common information commonly applied to all the users within the cell and the information applied only to the particular UE within the cell, etc.

A specific example of a scheme for transmitting changed SI according to these parameters or these detailed criteria will be described below in more detail with reference to the accompanying drawings.

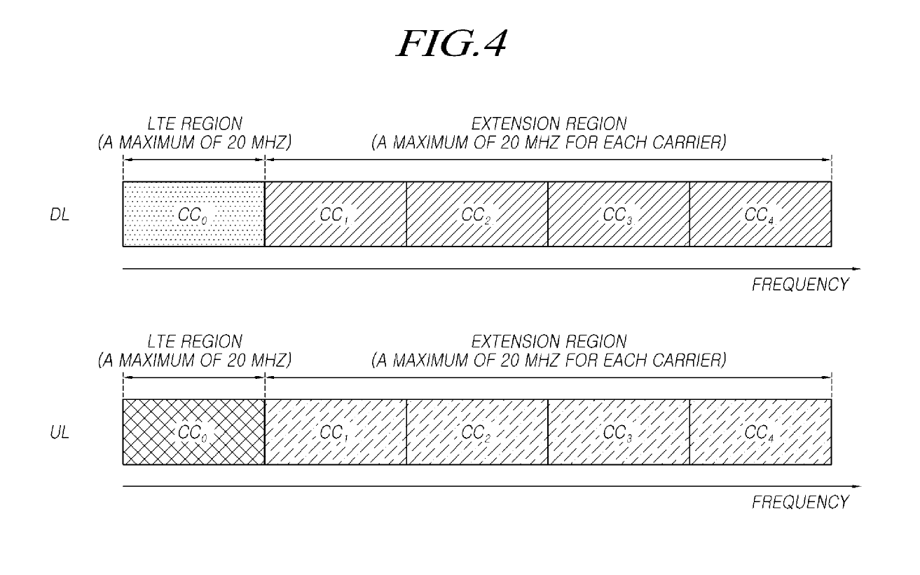

FIG. 4 is a view showing an example of a component carrier which may be used in the present invention.

As shown in FIG. 4, each CC is defined as having a predetermined frequency bandwidth (a maximum of 20 MHz), and is a CC of one of three types, such as a backwards compatible carrier, a non-backwards compatible carrier, and an extension carrier, as described above. It goes without saying that a new CC is also included in CCs of the present invention when a characteristic of the CC is newly defined.

In an environment of the multiple CCs, a UE may be allocated multiple CCs, each of which enables the reception of a signal. For an appropriate operation of each allocated CC, the UE needs to acquire up-to-date SI of each CC.

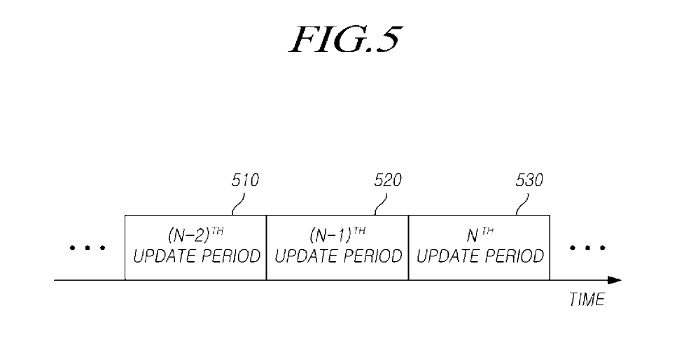

FIG. 5 shows a timing diagram in which system information is updated according to an embodiment of the present invention.

As shown in FIG. 5, a change of SI is made only during a preset period. These preset periods are called update periods 510, 520 and 530. Each of the update periods 510, 520 and 530 may be defined as an integer multiple of a radio frame, and a change thereof may be made.

In order to transmit the changed SI to a UE and apply the changed SI to the UE, the following two schemes may be used. The two schemes may be: a two-step update scheme for first transmitting, at least once, information reporting a change of SI during an (n-1)^{th} update period (reference numeral 520 in FIG. 5) and then transmitting the changed SI during an n^{th} update period (reference numeral 530 in FIG. 5); and a scheme for simultaneously performing the two steps.

Herein, information reporting a change of SI may be SI change notification information in a first embodiment or SI validity verification information in a second embodiment, which will be described below.

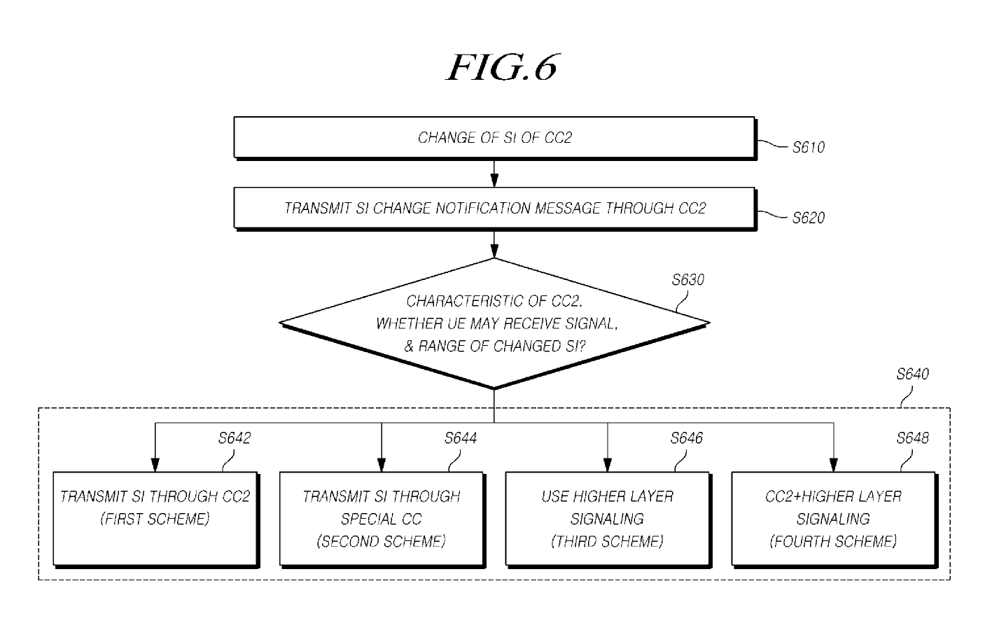

FIG. 6 is a flowchart showing a method for transmitting SI according to a first embodiment of the present invention.

According to the first embodiment of the present invention, a method for transmitting changed SI of a particular CC (e.g. a CC2) to a UE when the SI of the particular CC is changed (S610) in a wireless communication system using multiple CCs, may include: transmitting an SI change notification message including SI change notification information of the CC (i.e. the CC2), the SI of which has been changed, to the UE through the relevant CC (i.e. the CC2) (S620) as shown in FIG. 6; and transmitting (S640) the changed SI to the UE in one or more of the following four schemes determined (S630) based on one or more of a characteristic of the CC (i.e. the CC2) , the SI of which has been changed, whether the UE may receive a signal, and a range of the changed SI. The SI change notification message in step S620 may also be transmitted through the special CC as described above.

In the first embodiment, the four schemes in step S640 of transmitting the changed SI to the UE may include: 1) a first scheme (S642) for transmitting the changed SI through the relevant CC, the SI of which has been changed, 2) a second scheme (S644) for transmitting the changed SI through a predetermined special CC, 3) a third scheme (S646) for transmitting the changed SI through higher layer signaling, 4) a fourth scheme (S648) for transmitting SI for only a particular UE among the multiple pieces of changed SI through higher layer signaling, and for transmitting SI, which is commonly applied to all UEs within a cell among the multiple pieces of changed SI, through the relevant CC, the SI of which has been changed. Also, with the second scheme in step S644 or with the third scheme in step S646, SI may be transmitted through a special CC.

Namely, in the first embodiment as shown in FIG. 6, in a method for including information notifying of only whether SI has been changed (SI change notification information) in a signal transmitted during every period at periodic intervals, or during every preset period at aperiodic intervals, a paging message used both in an RRC-connected state and in an idle state may be used. However, the present invention is not limited to this configuration. Accordingly, another message having a function equivalent to that of the paging message may be used in this method.

Namely, another message or signal having a form in which it may be transmitted to the UE even in a stand-by or idle state between the UE and the BS, as well as in a state where the UE is connected to the BS (cell) through the relevant CC, may be used as the SI change notification message in the first embodiment.

When a CC does not enable the reception of necessary control information in a case where a paging message or a message equivalent to the paging message is received through the CC, SI of which has been changed, the paging message is transmitted through a designated CC after the designation of one of other CCs, through which the control information of the relevant CC may be received. Otherwise, only control information may be allocated to a preset special CC. However, the present invention is not limited to this configuration.

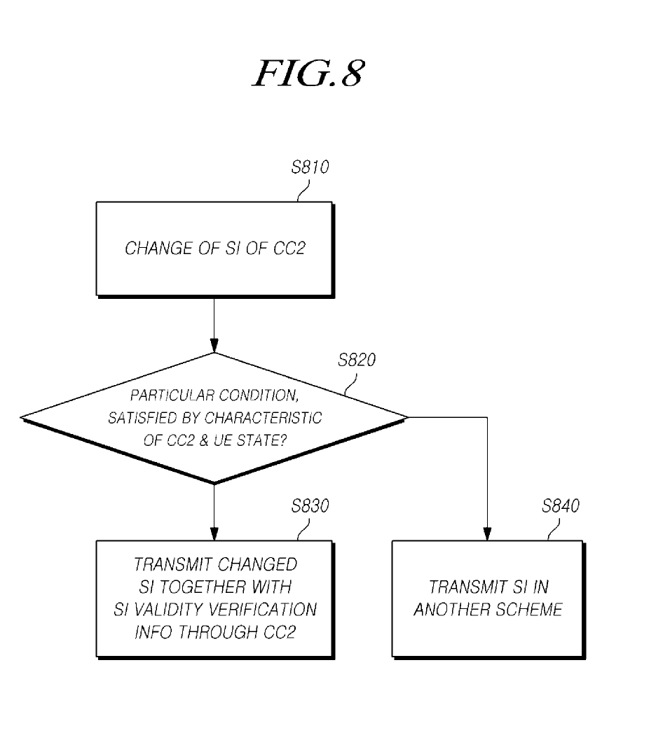

Parameters determining a scheme for transmitting/receiving SI and changed SI, the determination of a scheme for transmitting changed SI, etc., according to the present invention, will be specifically described all together in exemplary embodiments which will be described with reference to FIG. 8 and the accompanying drawings following FIG. 8.

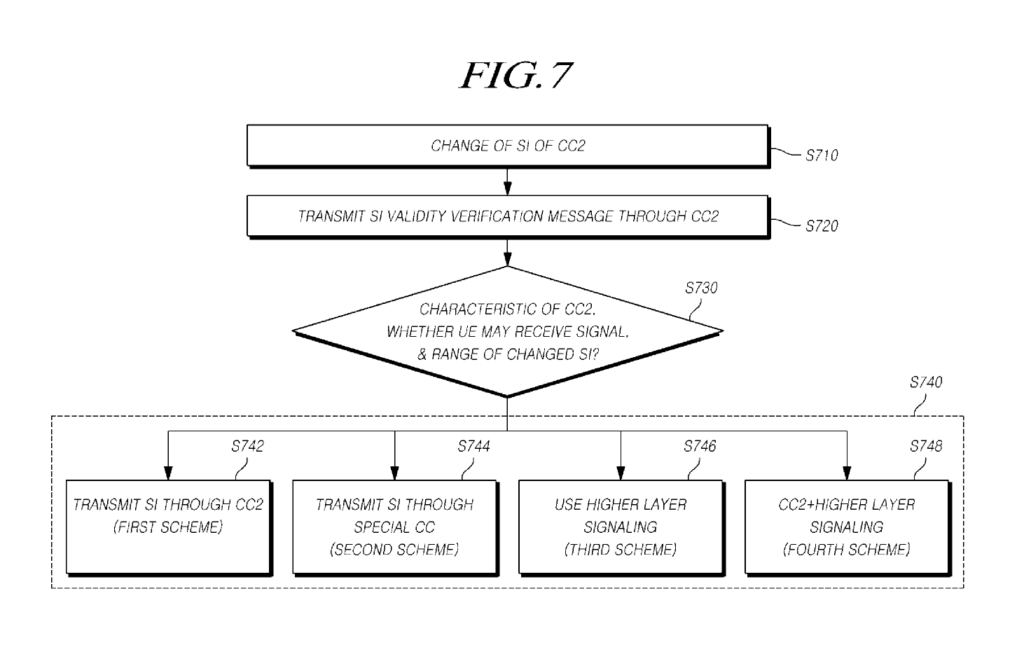

FIG. 7 is a flowchart showing a method for transmitting SI according to a second embodiment of the present invention.

According to the second embodiment of the present invention, a method for transmitting changed SI of a particular CC (e.g. a CC2) to a UE when the SI of the particular CC is changed (S710) in a wireless communication system using multiple CCs, may include: transmitting an SI validity verification message including SI validity verification information of the CC (i.e. the CC2), the SI of which has been changed, to the UE through the relevant CC (i.e. the CC2) (S720) as shown in FIG. 7; and transmitting (S740) the changed SI to the UE in one or more of the following four schemes determined (S730) based on one or more of a characteristic of the CC (i.e. the CC2), the SI of which has been changed, whether the UE may receive a signal, and a range of the changed SI. The SI validity verification message in step S720 may also be transmitted through the special CC as described above.

In the second embodiment, as in the first embodiment as shown in FIG. 6, the four schemes in step S740 of transmitting the changed SI to the UE may include: 1) a first scheme (S742) for transmitting the changed SI through the relevant CC, the SI of which has been changed, 2) a second scheme (S744) for transmitting the changed SI through a predetermined special CC, 3) a third scheme (S746) for transmitting the changed SI through higher layer signaling, 4) a fourth scheme (S748) for transmitting SI for only a particular UE among the multiple pieces of changed SI through higher layer signaling, and for transmitting SI, which is commonly applied to all UEs within a cell among the multiple pieces of changed SI, through the relevant CC, the SI of which has been changed. Also, with the second scheme in step S744 or with the third scheme in step S746, SI may be transmitted through a special CC.

In the second embodiment as shown in FIG. 7, the SI validity verification information may be included in a fixed and periodic SI transmission block or a message having a function equivalent to that of the fixed and periodic SI transmission block. However, the present invention is not limited to this configuration. An example of the SI validity verification message used in the second embodiment as shown in FIG. 7 may be a message including a value tag of a SIB1 or the like. However, the present invention is not limited to this configuration.

In the second embodiment as shown in FIG. 7, the SI validity verification information signifies information which enables the UE receiving SI to verify whether the SI is valid, and may be, for example, information included in a value tag of a SIB1. However, the present invention is not limited to this configuration.

Namely, in the second embodiment as shown in FIG. 7, a message transmitted through a broadcast channel used in an RRC-connected state may be used as an SI transmission message or an SI transmission block used in a method for including information enabling the verification of the validity of current SI in a signal transmitted during every period at periodic intervals, or during every preset period at aperiodic intervals. However, the present invention is not limited to this configuration. The SI transmission message or the SI transmission block may be another message having a function equivalent to that of the message transmitted through a broadcast channel.

In this specification, a fixed and periodic SI transmission message and a fixed and periodic SI transmission block are used as an equivalent concept.

When a CC does not enable the reception of necessary control information in a case where a fixed and periodic SI transmission block or a message having a function equivalent to that of the fixed and periodic SI transmission block is received through a CC, SI of which has been changed, SI validity verification information is transmitted after the designation of one of other CCs, through which the control information of the relevant CC may be received. Otherwise, only control information may be allocated to a preset special CC. However, the present invention is not limited to this configuration.

Also, in the third scheme and in the fourth scheme described in each of the first embodiment and the second embodiment, higher layer signaling may be signaling using a special CC. However, the present invention is not limited to this configuration. The higher layer signaling may be signaling using a CC, SI of which is not changed, other than the special CC.

In this specification, the term “higher layer signaling” refers to all concepts of defining and using a separate signal format or a signaling scheme for transmitting changed SI according to an exemplary embodiment of the present invention, without using typical SI, signaling other than the higher layer signaling, a signal format, and the like. For example, the higher layer signaling signifies a signal format or signaling according to an SFN (System Frame Number), or a separate signal format or separate signaling excluding a signal format or signaling according to a BCH (Broadcast CHannel), through which acquired SI is transmitted to a UE after the SI of another CC different from SI of its own CC is acquired. However, the present invention is not limited to this configuration.

Also, the higher layer signaling may be dedicated signaling for the transmission of data to only a particular UE. However, the present invention is not limited to this configuration.

FIG. 8 is a flowchart showing a method for transmitting SI according to a third embodiment of the present invention.

In the third embodiment of the present invention as shown in FIG. 8, a method for transmitting changed SI of a particular CC (e.g. a CC2) to a UE when the SI of the particular CC among multiple CCs is changed (S810), may include: transmitting (S830) the changed SI to the UE, together with an SI validity verification message including SI validity verification information of the relevant CC (i.e. the CC2), the SI of which has been changed, through the relevant CC (i.e. the CC2), the SI of which has been changed, according to whether a particular condition is satisfied (S820) by one or more parameters among a characteristic of the CC (i.e. the CC2), the SI of which has been changed, and whether the UE may receive a signal.

In the third embodiment, the term “particular condition” refers to a case where the CC, the SI of which has been changed, is a CC (a backwards compatible carrier or a non-backwards compatible carrier) which may be independently operated, where the UE is in a state of being capable of receiving all pieces of SI through the relevant CC, and where the UE is in a state of being capable of receiving data information through the relevant CC. At this time, the particular condition is irrelevant to whether the UE may receive control information through the relevant CC.

In the first embodiment to the third embodiment as shown in FIGS. 6 to 8, a characteristic of a CC, SI of which has been changed, whether a UE may receive a signal, the range of changed SI, and the like may be used as parameters determining a scheme for transmitting changed SI. These parameters may include the following detailed criteria.

Firstly, detailed criteria related to a characteristic of a CC, SI of which has been changed, may include: whether the relevant CC is an independently-operated CC or is a dependently-operated CC, whether control information may be transmitted through the relevant CC, whether SI may be transmitted through the relevant CC, whether the relevant CC has a Signal-to-Interference plus Noise Ratio (SINR) equal to or greater than a threshold, etc.

Secondly, detailed criteria related to whether a UE may receive a signal, may include: whether the UE may receive a signal through a CC, SI of which has been changed, whether the UE may receive a signal through a CC, SI of which is not changed, etc. Examples of these detailed criteria may include: whether the UE is in an activated state or in a non-activated state, whether a relevant CC is configured or non-configured to the UE, etc.

Thirdly, detailed criteria related to the range of changed SI may include: whether the changed SI is common information commonly applied to all users within a cell or is information applied only to a particular UE within the cell, whether the changed SI includes the common information commonly applied to all the users within the cell and the information applied only to the particular UE within the cell, etc.

System information described in this specification is a message in a Radio Resource Control (RRC) layer. The system information may include a System Information Block (SIB) including general system parameters, a Master Information Block (MIB) including limited parameters which are very often transmitted, a Scheduling Block (SB), etc. However, the present invention is not limited to this configuration. The MIB may include limited parameters which are very often transmitted, and the SB may include scheduling information on when different system information is transmitted. The MIB is transmitted on a fixed cycle through a Broadcast CHannel (BCH), and the SB and the SIB may be transmitted on a fixed or dynamic cycle through a DownLink Shared Channel (DL-SCH).

Each of the MIB, the SB and the SIB has a size changing according to set information. Each of a BCH and a DL-SCH for transmitting system information has a fixed size. Accordingly, a base station may first appropriately divide each of the MIB, SB and SIB and then transmit the divided MIB, the divided SB and the divided SIB, according to the size of a transmission channel. A UE may receive and recombine all of the divided MIB, the divided SB and the divided SIB. In order to receive a particular SIB using a dynamic cycle, the UE may continuously receive information through a DL-SCH until it receives all of the particular divided SIB. Otherwise, the UE may receive the divided pieces of the particular SIB by using information on the division and transmission scheduling of the particular SIB included in the SB.

As described above, SI is information essential to be connected through a CC and exchange data. In order to obtain SI of each CC, the UE must receive the SI at a frequency corresponding to the relevant CC.

Generally, SI and a scheme for receiving SI are configured from information and reception schemes, which have the following priority.

1) Reception of SI having the highest priority through a broadcast channel for which a physical radio resource has previously been determined.

2) Reception of SI having priority, a transmission cycle of which is preset, but which is transmitted by using dynamic allocation (position and bandwidth) of frequency resources.

3) Reception of SI which enables dynamically setting of a transmission cycle, the amount of allocated frequency resources, and the like based on the determination of whether SI is transmitted, according to a need resulting from a current wireless environment of a UE, a network state, and the like.

Accordingly, there may be a difference in configuration between multiple pieces of SI necessary for UEs, and thus a system needs to transmit SI necessary for each UE in view of this difference. Generally, SI is received in an order according to the priority.

Also, it may be assumed that the following states of the BS (system) and the UE are applied to the first embodiment to the third embodiment as shown in FIG. 6 to FIG. 8. However, the present invention is not limited to this configuration.

1) The BS may transmit a signal including SI change notification information through some of downlink component carriers that the BS may use.

2) The BS may transmit a signal including SI through some of downlink component carriers that the BS may use.

3) The UE has completed configuring of CCs, configuration information of each of which the UE has received from the BS, and may receive or may not receive information from the BS through a relevant CC.

4) A particular downlink CC and a particular uplink CC, through which each UE transmits and receives a control information signal and SI, may be designated for each UE. When there exists a CC which does not have a characteristic required to transmit and receive control information and SI among CCs, the relevant CC is excluded from the designation of a particular CC.

5) A characteristic of each CC used by the BS is not changed, but a characteristic of a CC defined within an identical frequency band may be different for each BS. However, a bandwidth of each CC is identical in all BSs.

6) The BS may transmit SI having the highest priority through each of all downlink CCs (including a CC, to which the exception of 4) is applied).

7) When the UE is not in a state of receiving information through all CCs, configuration information of each of which the UE has received from the BS, the UE may identify whether there exists a control signal or an information signal, which is transmitted from the BS at every preset cycle, and applies an identical operation to all the CCs.

Hereinafter, a description will be made of parameters determining a scheme for transmitting or receiving changed SI, such as a characteristic of a CC, SI of which has been changed, whether a UE may receive a signal, and the range of changed SI, and an example of determining a scheme for transmitting changed SI (the first scheme to the fourth scheme) based on detailed criteria of the parameters as described above, in the first embodiment and the second embodiment as shown in FIG. 6 and FIG. 7. However, the present invention is not limited to the following example.

First, CCs which are used to transmit changed SI in the first embodiment and the second embodiment, should all have an SINR equal to or greater than a particular threshold. Herein, the particular threshold signifies an SINR such that SI and data other than the SI, which are transmitted through the CC may be received by a particular UE while the SI and other data all have predetermined quality. This particular threshold may be changed according to QoS (Quality of Service), the type of data, etc., which are required.

Also, in the case of a change of SI of a CC which may be independently operated according to detailed criteria of a characteristic of a CC, SI of which has been changed, namely, a CC, such as a backwards compatible carrier and a non-backwards compatible carrier, which is independently operated (stand-alone), the first scheme is first used, the fourth scheme is then considered, and the second scheme or the third scheme is considered last of all.

Meanwhile, in the case of a change of SI of a CC which may not be independently operated according to the detailed criteria of a characteristic of a CC, SI of which has been changed, namely, a CC, such as an extension carrier, which is dependently or subordinately operated, the second scheme or the third scheme is first used, whereas it is difficult to apply the first scheme or the fourth scheme to the transmission of changed SI.

Also, when a relevant CC may be used to transmit control information or SI according to the detailed criteria of a characteristic of a CC, SI of which has been changed, transmitting of changed SI in the first scheme or the fourth scheme may be first considered, and the second scheme and the third scheme may be then considered. In contrast, when the relevant CC may not be used to transmit control information or SI, the second scheme or the third scheme may be employed instead of the first scheme or the fourth scheme.

Meanwhile, when a UE may receive a signal through a CC, SI of which has been changed according to detailed criteria of whether a UE may receive a signal, among the parameters, the first scheme to the fourth scheme may all be used for the transmission of changed SI. Also, the third embodiment may be applied to the transmission of changed SI. However, even in this case, a possible scheme may be limited according to the detailed criteria (whether a CC may be independently operated, whether a CC may be used to transmit control information, and whether a CC may be used to transmit SI) of a characteristic of a CC, SI of which has been changed, corresponding to another parameter.

Also, when there exists in a UE a CC which may be used to receive control information and a signal among CCs, SI of each of which is not changed, according to the detailed criteria of whether a UE may receive a signal, among the parameters, the third scheme or the fourth scheme may be selectively first applied to the transmission of changed SI. Otherwise, the first scheme or the second scheme may be considered.

Also, in a case where the remaining parameters enable all the two or more schemes among the four schemes to be applied to the transmission of changed SI according to identical priority, when there is only a change of a common part applied to all UEs within a cell according to the range of changed SI, in relation to the range of changed SI among the parameters, the first scheme or the second scheme is first applied. In contrast, when there is only a change of information limited to a particular UE, the third scheme is employed. When there exist all the two pieces of information, the four schemes may all be applied to the transmission of changed SI.

As described above, one or more of the four schemes for SI transmission may be selectively or first used according to the parameters including a characteristic of a CC, SI of which has been changed, whether a UE may receive a signal and the range of changed SI, and according to detailed criteria of each parameter. This method is not limited to the examples as described above, but may be implemented in many other scenarios.

Also, a typical method for transmitting changed SI to a UE and updating SI to the changed SI by the UE may correspond to, firstly, a scheme in which a BS transmits the entire changed SI to a UE and the UE updates SI to the newly-received SI after discarding all pieces of existing SI, or secondly, a scheme in which a BS transmits only SI corresponding to a changed part of the entire SI to a UE and the UE updates SI to the newly-received SI after discarding only changed SI among multiple pieces of existing SI.

A first scheme has an advantage in that it does not need to designate and report changed SI, but has a disadvantage in that it does not enable normal wireless transmission/reception until the completion of the reception of new SI. A second scheme has an advantage in that it enables normal wireless transmission/reception even during the update of SI when changed SI does not affect normal wireless transmission/reception. However, the second scheme has a disadvantage in that the amount of the entire SI is increased because an indicator indicating whether SI has been changed should be additionally included in each of all pieces of SI in order to designate and report the changed SI.

The first embodiment to the third embodiment as described above may basically employ the first scheme in which the BS transmits the entire changed SI and the UE updates SI to the newly-received SI after discarding all pieces of existing SI. However, the present invention is not limited to this example. As the case may be, they may employ the second scheme in which the BS transmits only SI corresponding to a changed part of the entire SI and the UE updates SI to the newly-received SI.

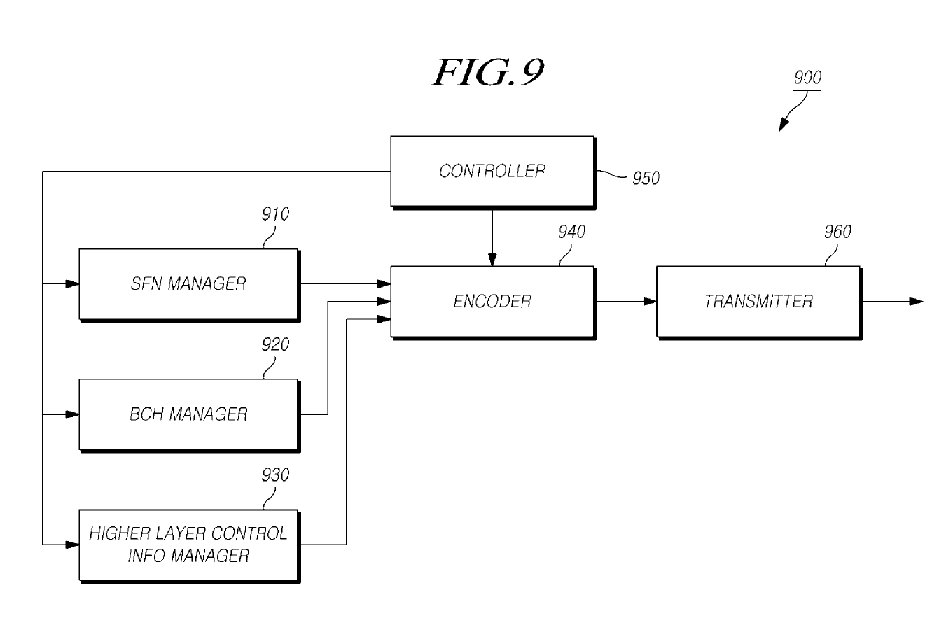

FIG. 9 is a block diagram showing the configuration of a device for transmitting changed SI, to which a method according to each of the first to third embodiments of the present invention is applied.

A device 900 for transmitting changed SI according to an exemplary embodiment of the present invention signifies a device which basically notifies the UE of SI change notification information or SI validity verification information of a particular CC through a relevant CC, and which basically transmits changed SI to the UE in one or more of the above four schemes determined based on one or more of a characteristic of a CC, SI of which has been changed, whether a UE may receive a signal, and the range of changed SI.

More specifically, the device 900 for transmitting changed SI includes, according to functions, an SFN manager 910, a BCH manager 920, a higher layer control information manager 930, an encoder 940, a controller 950, and a transmitter 960. However, the present invention is not limited to this configuration.

The SFN manager 910 which is a function unit for controlling and managing an SFN, increases an SFN in each radio frame. The SFN which is information included in system information, implies that information having a different value at every P-BCH (Public Broadcast CHannel) transmission cycle is discriminated from other pieces of P-BCH information, and the discriminated information is first separately encoded/repeated and is then transmitted through an agreed resource. However, the present invention is not limited to this configuration.

The BCH manager 920 which is a function unit for controlling and managing BCH information other than an SFN, first acquires SI of another CC as well as SI of itself and then transmits the acquired SI to the UE, particularly, according to an embodiment of the present invention.

Specifically, the BCH controller 920 included in an SI transmission device (namely, a device for transmitting SI) of a special CC (or special cell) through which the UE makes a signaling connection, may identify whether SI of another CC has been changed, and may transmit SI itself or changed SI of itself or SI itself or changed SI of another CC to the UE. At this time, SI generated and transmitted by the BCH controller is all pieces of information required to transmit and receive data through the relevant CC. For example, the SI may include information on a downlink (DL) carrier frequency (and an UL frequency which forms a pair with the DL carrier frequency) of a relevant CC, bandwidth (BW) information of the relevant CC, PCI information in a case where discrimination is made between CCs according to a Physical Cell ID (PCI), carrier index information, radio resource configuration information, temporary ID information, bandwidth-related information, and the like. However the present invention is not limited to this configuration.

Also, according to one of the first embodiment and the second embodiment as described above, the BCH manager 920 may perform a function for generating a message including SI validity verification information and transmitting the generated message to the UE, and a function for transmitting changed SI itself directly to the UE.

The higher layer control information manager 930 is an element for a case of employing the third scheme or the fourth scheme as a scheme for transmitting changed SI. A function of the higher layer control information manager 930 may be performed by the SFN manager 910 and the BCH manager 920. However, the higher layer control information manager 930 first defines dedicated signaling for transmitting changed SI of a higher layer which is not performed by the SFN manager 910 and the BCH manager 920, according to criteria defined by the third scheme or the fourth scheme, and then performs the dedicated signaling.

The encoder 940 is a block which encodes each of an SFN and BCH information according to a predetermined encoding method and a predetermined coding rate.

In a scheme for transmitting changed SI, which is determined by an exemplary embodiment of the present invention, the controller 950 adjusts a time point of transmitting information in each of the SFN manager 910, the BCH manager 920, and the higher layer control information manager 930, and adjusts an encoding method and a coding rate in an encoder 940.4

The transmitter 960 transmits the SFNs and the multiple pieces of BCH information encoded by the encoder 940 to a cell.

Namely, the device for transmitting changed SI according to an exemplary embodiment of the present invention is implemented in a base station (eNB or cell). However, the present invention is not limited to this configuration. Accordingly, the device for transmitting changed SI may be implemented in any other transmission device.

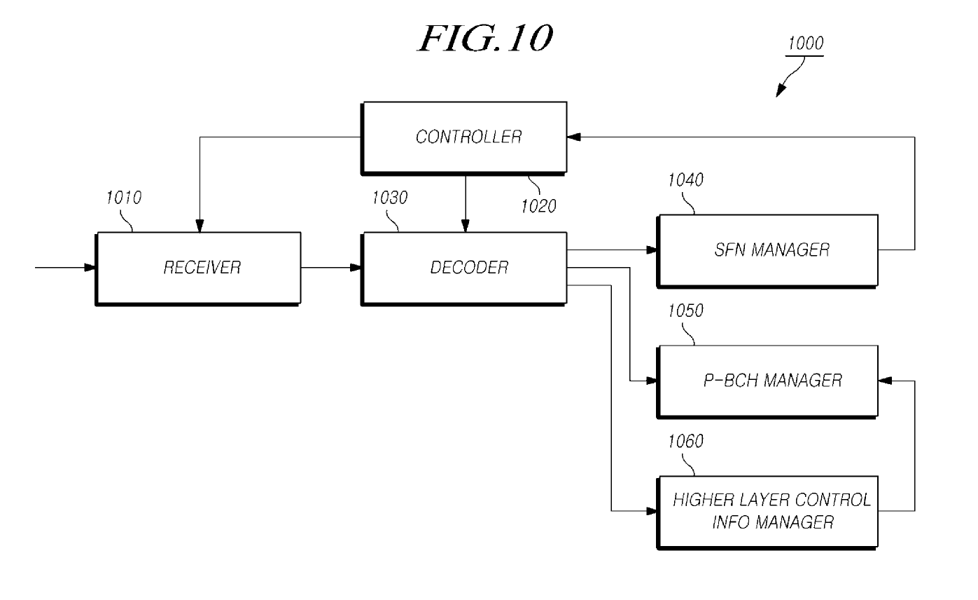

FIG. 10 is a block diagram showing the configuration of a device for receiving and updating SI according to an embodiment of the present invention.

The device for receiving and updating SI, as shown in FIG. 10 may be applied to the UE, and may receive SI in each of the methods as described above with reference to FIGS. 6, 7 and 8. For example, as shown in FIGS. 6 and 7, the UE may receive, from the BS, one or more of an SI change notification message including SI change notification information of a first CC, SI of which has been changed, and an SI validity verification message including SI validity verification information of the first CC, the SI of which has been changed. Also, the UE may receive the changed SI of the first CC from the BS in a predetermined scheme. It goes without saying that the above reception scheme may be any one of the following four schemes as described above. The four schemes may include: 1) the first scheme for receiving changed SI through the first CC, the SI of which has been changed, 2) the second scheme for receiving changed SI through a predetermined second CC, 3) the third scheme for receiving changed SI through higher layer signaling, 4) the fourth scheme for receiving SI for only a particular UE among the multiple pieces of changed SI through higher layer signaling, and for receiving SI which is commonly applied to all UEs within a cell among the multiple pieces of changed SI, through the first CC, the SI of which has been changed.

The second component carrier in the scheme signifies a special CC. Examples of the special CC may include an anchor carrier, a primary cell, a serving cell, and a special cell.

Also, as in the third embodiment shown in FIG. 8, the UE may first receive changed SI together with an SI validity verification message including SI validity verification information of a CC, the SI of which has been changed, through the CC, the SI of which has been changed, according to a result of determining of a characteristic of the CC, the SI of which has been changed, or a characteristic of a UE, the state of which has been changed, by the BS; and may then update SI by using the received changed SI. The BS determines a characteristic of the CC or a characteristic of the UE. Herein, the determination may be the determination of a case where the component carrier, the system information of which has been changed, corresponds to a component carrier capable of being independently operated, or the determination of a case where the UE is in a state of being capable of receiving all pieces of SI and data through the CC.

A device 1000 for receiving and updating SI according to an embodiment of the present invention is a device which performs a function for receiving SI change notification information or SI validity verification information and changed SI itself of a particular CC, which have been transmitted by the device 900 for transmitting changed SI as described above, and a function for updating SI of the particular CC to the received changed SI thereof.

In this case, one or more of the following four schemes may be used as a scheme for receiving changed SI itself. The four schemes include: 1) a first scheme for receiving changed SI through a relevant CC, the SI of which has been changed, 2) a second scheme for receiving changed SI through a predetermined special CC, 3) a third scheme for receiving changed SI through higher layer signaling, and 4) a fourth scheme for receiving SI for only a particular UE among the multiple pieces of changed SI through higher layer signaling, and for receiving SI, which is commonly applied to all UEs within a cell among the multiple pieces of changed SI, through the relevant CC, the SI of which has been changed.

Although the device for receiving SI according to an embodiment of the present invention is mainly implemented in the UE, the present invention is not limited to this configuration. The device has the concept of including all communication-related devices for acquiring and using SI.

The device 1000 for receiving and updating SI, as shown FIG. 10 includes a receiver 1010, a controller 1020, a decoder 1030, an SFN manager 1040, a P-BCH manager 1050, and a higher layer control information manager 1060. However, the present invention is not limited to this configuration.

More specifically, the receiver 810 simultaneously receives an SI change notification message or an SI validity verification message and changed SI, or receives them at intervals, from the device 900 for transmitting changed SI.

The controller 1020 controls the application of a decoding method and a decoding rate to the multiple pieces of SI received through the receiver 1010. At this time, the controller 1020 may perform a control operation so as to apply different decoding methods and decoding rates to an SFN, BCH information other than the SFN, and additionally-defined higher layer signaling information.

Also, the controller 1020 performs a function for updating SI of a relevant CC by using the SI change notification message or the SI validity verification message and the changed SI, which have been received simultaneously or at intervals, as will be described below. This update function will be described below in more detail.

The decoder 1030 decodes the SFN information, the BCH information, and the higher layer signaling information according to the control of the controller 1020. The decoded SFN information, the decoded BCH information, and the decoded higher layer signaling information after going through the decoder 1030 are separately input to the SFN manager 1040 and the P-BCH manager 1050, and the higher layer control information manager 1060, respectively. Then, the decoded SFN information, the decoded BCH information, and the decoded higher layer signaling information are controlled and managed by the SFN manager 1040 and the P-BCH manager 1050, and the higher layer control information manager 1060, respectively.

The SFN manager 1040 may identify the continuity of the received SFNs, and may additionally receive SFNs of the next cycle under the control of the controller 1020 according to the result of the identification.

When the P-BCH manager 1050 has failed to successfully receive the BCH information, it first stores the received BCH information in a buffer, and then combines the read BCH information with BCH information received at the next cycle according to the control of the controller 1020.

The P-BCH manager 1050 of the device for receiving and updating SI according to an embodiment of the present invention may identify SI of the special CC and SI of another CC based on SI received from the SI transmission device of a special CC (or special cell) which is not a changed CC but a separate CC, and, particularly, may acquire changed SI of the special CC and changed SI of another CC.

Hereinafter, an example of a process of updating SI by the device 1000 for receiving and updating SI, as shown in FIG. 10 will be described for each of the first to third embodiments as described with reference to FIGS. 6 to 8.

### Updating of SI According to a First Embodiment

The device 1000 for receiving and updating SI identifies the reception of an SI change notification message according to the first embodiment at a time point of completion of an (n-1)^{th} SI update period. When a change of SI is identified, the existing SI of a relevant CC (namely, a CC, the SI of which has been changed) is discarded.

Then, during an n^{th} update period, 1) the device 1000 for receiving and updating SI receives SI of the relevant CC transmitted through the relevant CC in the first scheme, or 2) the device 1000 for receiving and updating SI receives SI of the relevant CC transmitted through a special CC in the second scheme, or 3) the device 1000 for receiving and updating SI receives SI of the relevant CC transmitted through higher layer signaling in the third scheme, or 4) the device 1000 for receiving and updating SI receives SI of the relevant CC, in the fourth scheme, when SI for only a particular UE is transmitted through higher layer signaling, and when SI commonly applied to all UEs within a cell is transmitted through the relevant CC.

Then, SI of the relevant CC is updated by using the received changed SI. Accordingly, when an n^{th} update period passes, the update of SI of the relevant CC is completed.

In the first embodiment, it is desirable that the higher layer signaling as described above may be transmitted through a special CC. Otherwise, a CC other than the special CC, SI of which is not changed, may be selected, and may be used to transmit the higher layer signaling.

### Updating of SI According to a Second Embodiment

The device 1000 for receiving and updating SI first identifies the reception of SI validity verification information according to the second embodiment of the present invention at a time point of completion of an (n-1)^{th} SI update period, and then verifies the validity of the SI.

When a result of the verification shows that the SI validity verification fails, the existing SI of a relevant CC (namely, a CC, the SI of which has been changed) is discarded.

Then, during an n^{th} update period, 1) the device 1000 for receiving and updating SI receives SI of the relevant CC transmitted through the relevant CC in the first scheme, or 2) the device 1000 for receiving and updating SI receives SI of the relevant CC transmitted through a special CC in the second scheme, or 3) the device 1000 for receiving and updating SI receives SI of the relevant CC transmitted through higher layer signaling in the third scheme, or 4) the device 1000 for receiving and updating SI receives SI of the relevant CC, in the fourth scheme, when SI for only a particular UE is transmitted through higher layer signaling, and when SI commonly applied to all UEs within a cell is transmitted through the relevant CC.

Then, SI of the relevant CC is updated by using the received changed SI. Accordingly, when an n^{th} update period passes, the update of SI of the relevant CC is completed.

In the second embodiment, it is desirable that the higher layer signaling as described above may be transmitted through a special CC. Otherwise, a CC other than the special CC, SI of which is not changed, may be selected, and may be used to transmit the higher layer signaling.

### Updating of SI According to a Third Embodiment

During an SI update period, the device 1000 for receiving and updating SI receives SI validity verification information and changed SI itself, which have been simultaneously transmitted by the device for transmitting changed SI, and stores the SI validity verification information and the changed SI in a memory.

Then, the device 1000 for receiving and updating SI verifies the validity of the SI. When a result of the verification shows that the SI validity verification fails, the device 1000 for receiving and updating SI discards the existing SI of a relevant CC, and immediately updates SI to SI stored in the memory.

The third embodiment as described above is performed under a condition where the UE may receive all pieces of SI through the relevant CC and may receive data information through the relevant CC condition. Also, in the third embodiment as described above, in order to transmit changed SI, the device for transmitting changed SI first includes SI validity verification information in a fixed and periodic SI transmission message or a message having a function equivalent to that of the fixed and periodic SI transmission message, and then transmits SI including the changed SI through a CC, SI of which has been changed.

Whether the UE is capable of receiving control information through the relevant CC, may be irrelevant to the above conditions.

According to the exemplary embodiments as described above, in transmitting changed SI to the UE and updating SI by using the received changed SI when the SI of a particular CC is changed in a carrier aggregation environment where multiple CCs are used, while there is no occurrence of an increase in the amount of additional signals and power consumption, which are caused by using a scheme for SI change notification as it is, a scheme for transmitting SI is determined according to priority between the amount of power consumption and QoS (Quality of Service) based on a characteristic of a relevant CC, the state of the UE, the range of changed SI, and the like, in the case of transmitting information of the relevant CC, the SI of which has been changed. Therefore, there is an advantage in that it is possible to efficiently transmit SI to the UE and efficiently update SI by using the received SI.

Although the above description is only an illustrative description of the technical idea of the present invention, those having ordinary knowledge in the technical field of the present invention will appreciate that various modifications, additions and substitutions are possible, without departing from the scope and spirit of the invention as disclosed in the appended claims. Therefore, the embodiments disclosed in the present invention are intended to illustrate the scope of the technical idea of the present invention, and the scope of the technical is idea of the present invention is not limited by the embodiments. The protection scope of the present invention should be construed based on the accompanying claims, and all of the technical ideas included within the scope equivalent to the claims should be construed as being included within the right scope of the present invention.

1. A method for transmitting system information (SI) in a wireless communication system using one or more component carriers, the method comprising:
transmitting, to a user equipment, one or more of an SI change notification message including SI change notification information of a first component carrier, system information of which has been changed, and an SI validity verification message including SI validity verification information of the first component carrier, the system information of which has been changed;
determining a scheme for transmitting the changed system information based on one or more of a characteristic of the first component carrier, the system information of which has been changed, whether the user equipment is capable of receiving a signal, and a range of the changed system information; and
transmitting the changed system information to the user equipment in the determined scheme,
wherein the scheme for transmitting the changed system information corresponds to any one of:
1) a first scheme for transmitting the changed system information through the first component carrier, the system information of which has been changed;
2) a second scheme for transmitting the changed system information through a predetermined second component carrier;
3) a third scheme for transmitting the changed system information through higher layer signaling; and
4) a fourth scheme for transmitting system information for only a particular user equipment among multiple pieces of the changed system information through the higher layer signaling, and for transmitting system information, which is commonly applied to all user equipments within a cell among the multiple pieces of changed system information, through the first component carrier, the system information of which has been changed.

2. The method as claimed in claim 1, wherein the second component carrier corresponds to one or more of an anchor carrier, a primary cell, a serving cell, and a special cell.

3. The method as claimed in claim 1, wherein the SI change notification message corresponds to a paging message, and the SI validity verification message corresponds to a fixed and periodic SI transmission message.

4. The method as claimed in claim 1, wherein the characteristic of the first component carrier, the system information of which has been changed, as a parameter determining the scheme for transmitting the changed system information corresponds to one or more of:
whether the first component carrier is an independently-operated component carrier or is a dependently-operated component carrier;
whether the first component carrier is capable of being used to transmit control information;
whether the first component carrier is capable of being used to transmit system information; and
whether the first component carrier has a signal-to-interference plus noise ratio (SINR) equal to or greater than a particular threshold.

5. The method as claimed in claim 1, wherein whether the user equipment is capable of receiving the signal, as a parameter determining the scheme for transmitting the changed system information corresponds to one or more of:
whether the user equipment is capable of receiving a signal through a component carrier, system information of which has been changed; and
whether the user equipment is capable of receiving a signal through a component carrier, system information of which is not changed.

6. The method as claimed in claim 1, wherein the range of the changed system information, as a parameter determining the scheme for transmitting the changed system information corresponds to one or more of:
whether the changed system information is common information commonly applied to all users within a cell;
whether the changed system information is information applied only to a particular user equipment within the cell; and
whether the changed system information comprises the common information commonly applied to all the users within the cell and the information applied only to the particular user equipment within the cell.

7. A method for transmitting system information (SI) in a wireless communication system using one or more component carriers, the method comprising:
determining a characteristic of a component carrier, system information of which has been changed, or a characteristic of a user equipment, a state of which has been changed; and
transmitting the changed system information together with an SI validity verification message including SI validity verification information of the component carrier, the system information of which has been changed, to the user equipment through the component carrier, the system information of which has been changed, according to a result of determining of the characteristic.

8. The method as claimed in claim 7, wherein determining of the characteristic further comprises
identifying whether one or more parameters among the characteristic of the component carrier, the system information of which has been changed, and whether the user equipment is capable of receiving a signal satisfy particular conditions,
wherein the particular conditions comprise:
a condition such that the component carrier, the system information of which has been changed, is a component carrier capable of being independently operated; and
a condition such that the user equipment is in a state of being capable of receiving all pieces of system information and data through a relevant component carrier.

9. A method for receiving system information (SI) in a wireless communication system using one or more component carriers, the method comprising:
receiving, from a base station, one or more of an SI change notification message including SI change notification information of a first component carrier, system information of which has been changed, and an SI validity verification message including SI validity verification information of the first component carrier, the system information of which has been changed; and
receiving the changed system information of the first component carrier from the base station in a scheme determined by the base station,
wherein the scheme determined by the base station corresponds to any one of:
1) a first scheme for receiving the changed system information through the first component carrier, the system information of which has been changed;
2) a second scheme for receiving the changed system information through a predetermined second component carrier;
3) a third scheme for receiving the changed system information through higher layer signaling; and
4) a fourth scheme for receiving system information for only a particular user equipment among multiple pieces of the changed system information through the higher layer signaling, and for receiving system information, which is commonly applied to all user equipments within a cell among the multiple pieces of changed system information, through the first component carrier, the system information of which has been changed.

10. The method as claimed in claim 9, wherein the second component carrier corresponds to one or more of an anchor carrier, a primary cell, a serving cell, and a special cell.

11. The method as claimed in claim 9, wherein the SI change notification message corresponds to a paging message, and the SI validity verification message corresponds to a fixed and periodic SI transmission message.

12. A method for receiving system information (SI) in a wireless communication system using one or more component carriers, the method comprising:
receiving changed system information together with an SI validity verification message including SI validity verification information of a component carrier, the system information of which has been changed, through the component carrier, the system information of which has been changed, according to a result of determining, by a base station, a characteristic of the component carrier, the system information of which has been changed, or a characteristic of a user equipment, a state of which has been changed; and updating the system information by using the received system information.

13. The method as claimed in claim 12, wherein the component carrier, the system information of which has been changed, corresponds to a component carrier capable of being independently operated, or the user equipment is in a state of being capable of receiving all pieces of system information and data through the component carrier.

14. A device to transmit system information (SI) in a base station to transmit system information in a wireless communication system using one or more component carriers, the device comprising:
a transmitter to transmit, to a user equipment, one or more of an SI change notification message including SI change notification information of a first component carrier, system information of which has been changed, and an SI validity verification message including SI validity verification information of the first component carrier, the system information of which has been changed; and
a controller to determine a scheme for transmitting the changed system information based on one or more of a characteristic of the first component carrier, the system information of which has been changed, whether the user equipment is capable of receiving a signal, and a range of the changed system information,
wherein the transmitter transmits the changed system information to the user equipment in the scheme determined by the controller, and
wherein the scheme in which the transmitter transmits the changed system information, corresponds to any one of:
1) a first scheme for transmitting the changed system information through the first component carrier, the system information of which has been changed;
2) a second scheme for transmitting the changed system information through a predetermined second component carrier;
3) a third scheme for transmitting the changed system information through higher layer signaling; and
4) a fourth scheme for transmitting system information for only a particular user equipment among multiple pieces of the changed system information through the higher layer signaling, and for transmitting system information, which is commonly applied to all user equipments within a cell among the multiple pieces of changed system information, through the first component carrier, the system information of which has been changed.

15. The device as claimed in claim 14, wherein the second component carrier corresponds to one or more of an anchor carrier, a primary cell, a serving cell, and a special cell.

16. The device as claimed in claim 14, wherein the SI change notification message corresponds to a paging message, and the SI validity verification message corresponds to a fixed and periodic SI transmission message.

17. The device as claimed in claim 14, wherein the characteristic of the first component carrier, the system information of which has been changed, as a parameter determining the scheme for transmitting the changed system information corresponds to one or more of:
whether the first component carrier is an independently-operated component carrier or is a dependently-operated component carrier;
whether the first component carrier is capable of being used to transmit control information;
whether the first component carrier is capable of being used to transmit system information; and
whether the first component carrier has a signal-to-interference plus noise ratio (SINR) equal to or greater than a particular threshold.

18. The device as claimed in claim 14, wherein whether the user equipment is capable of receiving the signal, as a parameter determining the scheme for transmitting the changed system information corresponds to one or more of:
whether the user equipment is capable of receiving a signal through a component carrier, system information of which has been changed; and
whether the user equipment is capable of receiving a signal through a component carrier, system information of which is not changed.

19. The device as claimed in claim 14, wherein the range of the changed system information, as a parameter determining the scheme for transmitting the changed system information corresponds to one or more of:
whether the changed system information is common information commonly applied to all users within a cell;
whether the changed system information is information applied only to a particular user equipment within the cell; and
whether the changed system information comprises the common information commonly applied to all the users within the cell and the information applied only to the particular user equipment within the cell.

20. A device to transmit system information (SI) in a wireless communication system using one or more component carriers, the device comprising:
a controller to determine a characteristic of a component carrier, system information of which has been changed, or a characteristic of a user equipment, a state of which has been changed; and
a transmitter to transmit the changed system information together with an SI validity verification message including SI validity verification information of the component carrier, the system information of which has been changed, to the user equipment through the component carrier, the system information of which has been changed, according to a result of determining of the characteristic.

21. The device as claimed in claim 20, wherein the controller identifies whether one or more parameters among the characteristic of the component carrier, the system information of which has been changed, and whether the user equipment is capable of receiving a signal satisfy particular conditions,
wherein the particular conditions comprise:
a condition such that the component carrier, the system information of which has been changed, is a component carrier capable of being independently operated; and
a condition such that the user equipment is in a state of being capable of receiving all pieces of system information and data through a relevant component carrier.

22. A device to receive system information (SI) in a device to receive and update system information in a wireless communication system using one or more component carriers, the device comprising:
a receiver to receivefor rccciving, from a base station, one or more of an SI change notification message including SI change notification information of a first component carrier, system information of which has been changed, and an SI validity verification message including SI validity verification information of the first component carrier, the system information of which has been changed, and for receiving the changed system information of the first component carrier from the base station in a scheme determined by the base station; and
a controller to control the receiver so as to receive one or more of the SI change notification message or the SI validity verification message in the scheme determined by the base station, and updating the system information by using the received system information,
wherein the scheme determined by the base station corresponds to any one of:
1) a first scheme for receiving the changed system information through the first component carrier, the system information of which has been changed;
2) a second scheme for receiving the changed system information through a predetermined second component carrier;
3) a third scheme for receiving the changed system information through higher layer signaling; and
4) a fourth scheme for receiving system information for only a particular user equipment among multiple pieces of the changed system information through the higher layer signaling, and for receiving system information, which is commonly applied to all user equipments within a cell among the multiple pieces of changed system information, through the first component carrier, the system information of which has been changed.

23. The device as claimed in claim 22, wherein the second component carrier corresponds to one or more of an anchor carrier, a primary cell, a serving cell, and a special cell.

24. The device as claimed in claim 22, wherein the SI change notification message corresponds to a paging message, and the SI validity verification message corresponds to a fixed and periodic SI transmission message.

25. A device to receive system information (SI) in a device to receive and update system information in a wireless communication system using one or more component carriers, the device comprising:
a receiver to receive changed system information together with an SI validity verification message including SI validity verification information of a component carrier, the system information of which has been changed, through the component carrier, the system information of which has been changed, according to a result of determining, by a base station, a characteristic of the component carrier, the system information of which has been changed, or a characteristic of a user equipment, a state of which has been changed; and
a controller to update the system information by using the received system information.

26. The device as claimed in claim 25, wherein the component carrier, the system information of which has been changed, corresponds to a component carrier capable of being independently operated, or the user equipment is in a state of being capable of receiving all pieces of system information and data through the component carrier.
